(19) United States
(12) Patent Application Publication
(10) Pub. No.: US 2004/0071195 A1
(43) Pub. Date: Apr. 15, 2004

(54) Method and electronic device for a spread spectrum signal

(76) Inventors: Xiaojing Huang, Waverton (AU); Yunxin Li, Ryde (AU)

Correspondence Address: MOTOROLA, INC., 1303 EAST ALGONQUIN ROAD, IL01/3RD, SCHAUMBURG, IL, 60196

(21) Appl. No.: 10/269,633

(22) Filed: Oct. 11, 2002

(51) Int. Cl. H04B 1/69

(52) U.S. Cl. 375/146; 375/147

(57) ABSTRACT

A device (100) and method (700) for creating a spread spectrum signal by providing a complementary code spreading signal (740) having an auto-correlation function of zero, for any non-zero offset, at integer multiples of a selected time interval. The method includes modulating (750) a data stream with the complementary code spreading signal to provide the spread spectrum signal.

There is also described a method (800) for decoding a spread spectrum signal to provide a data stream by providing a complementary code despreading signal (840) having an auto-correlation function of zero, for any non-zero offset, at integer multiples of a selected time interval. The method (800) includes demodulating (850) the spread spectrum signal with the complementary code despreading signal to provide the data stream.

### FIELD OF THE INVENTION

This invention relates to a spread spectrum system, an electronic device for providing a spread spectrum signal and an associated method for providing a spread spectrum signal. The invention is particularly useful for, but not necessarily limited to, systems and devices with radio frequency communication links.

### BACKGROUND OF THE INVENTION

Spread spectrum signal technologies have been used for anti-jamming and security communications systems as well as commercial cellular and other wireless communications networks. Conventional Spread Spectrum signal systems use a pseudo-random spreading sequence such as Barker sequence that is used in the I.E.E.E.802.11 wireless LAN standard. However, the prior art single pseudo-random spreading sequences of finite length cannot have an auto-correlation function that is guaranteed to eliminate inter-symbol interference.

In this specification, including the claims, the terms ‘comprises’, ‘comprising’ or similar terms are intended to mean a non-exclusive inclusion, such that a method or apparatus that comprises a list of elements does not include those elements solely, but may well include other elements not listed.

### SUMMARY OF THE INVENTION

According to one aspect of the invention there is provided a method for creating a spread spectrum signal, the spread spectrum signal being created by the steps of:

providing a complementary code spreading signal having an auto-correlation function of zero, for any non-zero offset, at integer multiples of a selected time interval; and

modulating a data stream with the complementary code spreading signal to provide the spread spectrum signal.

Suitably, the complementary code spreading signal is obtained from the steps of:

providing a set of complementary sequences with the property that the sum of their respective auto-correlation functions is zero for any non-zero offset;

providing an orthogonal waveform set of at least two orthogonal waveforms, wherein a cross correlation of any two of the orthogonal waveforms of the set is zero;

multiplying each of the complementary sequences with a respective one of the orthogonal waveforms to provide intermediate spreading signals; and

summing the intermediate spreading signals to provide said complementary code spreading signal.

Preferably, the orthogonal waveform set can be a time division orthogonal waveform set. The orthogonal waveform set may suitably be a code division orthogonal waveform set. In another suitable form the orthogonal waveform set may be a frequency division waveform set.

Preferably, the spread spectrum signal may be summed with other spread spectrum signals that are generated by other mutually orthogonal complementary code spreading signals, wherein all complementary code spreading signals have an auto-correlation function of zero, for any non-zero offset, at integer multiples of a selected time interval.

According to another aspect of the invention there is provided a method for decoding a spread spectrum signal to provide a data stream, the method comprising the steps of:

providing a complementary code despreading signal having an auto-correlation function of zero, for any non-zero offset, at integer multiples of a selected time interval; and

demodulating the spread spectrum signal with the complementary code despreading signal to provide said data stream.

Suitably, the complementary code despreading signal is obtained from the steps of:

providing a set of complementary sequences with the property that the sum of their respective auto-correlation functions is zero for any non-zero offset;

providing an orthogonal waveform set of at least two orthogonal waveforms, wherein a cross correlation of any two of the orthogonal waveforms of the set is zero;

multiplying each of the complementary sequences with a respective one of the orthogonal waveforms to provide intermediate despreading signals; and

summing the intermediate despreading signals to provide said complementary code despreading signal.

Preferably, the orthogonal waveform set can be a time division orthogonal waveform set. The orthogonal waveform set may suitably be a code division orthogonal waveform set. In another suitable form the orthogonal waveform set may be a frequency division waveform set.

According to another aspect of the invention there is provided an electronic device for providing a spread spectrum signal, the device comprising:

a spread spectrum signal encoder having at least one input coupled to an output of signal providing circuitry;

an output unit coupled to spread spectrum signal encoder, wherein, in use, the encoder modulates a data stream provided from the signal providing circuitry with a complementary code spreading signal to provide the spread spectrum signal, the complementary code spreading signal having an auto-correlation function of zero, for any non-zero offset, at integer multiples of a selected time interval.

The electronic device may also include an input unit coupled to a spectrum signal decoder, wherein the spectrum signal decoder decodes a received spread spectrum signals received at the input unit to provide a decoded data stream.

Preferably, the spread spectrum signal encoder may comprise a plurality of data stream spreading modules coupled to an adder, wherein in use data streams are provided to the spreading modules to provide a respective spread spectrum signals that is summed together, the respective spread spectrum signals being generated by associated mutually orthogonal complementary code spreading sequences, wherein all complementary code spreading signals have an auto-correlation function of zero, for any non-zero offset, at integer multiples of a selected time interval.

Suitably, the output unit may include a radio transmitter.

The output unit may include a modem.

The electronic device may be a radio communication device such as a two-way radio communication device and the digital signal providing circuitry may be coupled to a microphone. Typically, the signal providing circuitry may preferably include a digital data store.

The electronic device may form part of a spread spectrum system comprising at least one further said electronic device in communication therewith.

### BRIEF DESCRIPTION OF THE DRAWINGS

In order that the invention may be readily understood and put into practical effect, reference will now be made to a preferred embodiment as illustrated with reference to the accompanying drawings in which:

FIG. 1 is a schematic block diagram of an electronic device for providing a spread spectrum signal in accordance with the invention;

FIG. 2 is a schematic block diagram of a spread spectrum signal encoder comprising part of the electronic device of FIG. 1;

FIG. 3 is a schematic block diagram of a spread spectrum signal decoder comprising part of the electronic device of FIG. 1;

FIG. 4 is a schematic diagram illustrating how a complementary code spreading signal, for use in the encoder of FIG. 2, can be derived;

FIG. 5a to 5c illustrates different forms of complementary code spreading sequences;

FIG. 6 is a schematic block diagram of a spread spectrum signal communication system;

FIG. 7 is a flow diagram illustrating a method for creating a spread spectrum signal in accordance with the present invention; and

FIG. 8 is a flow diagram illustrating a method for decoding a spread spectrum signal in accordance with the present invention.

### DETAILED DESCRIPTION OF A PREFERRED EMBODIMENT OF THE INVENTION

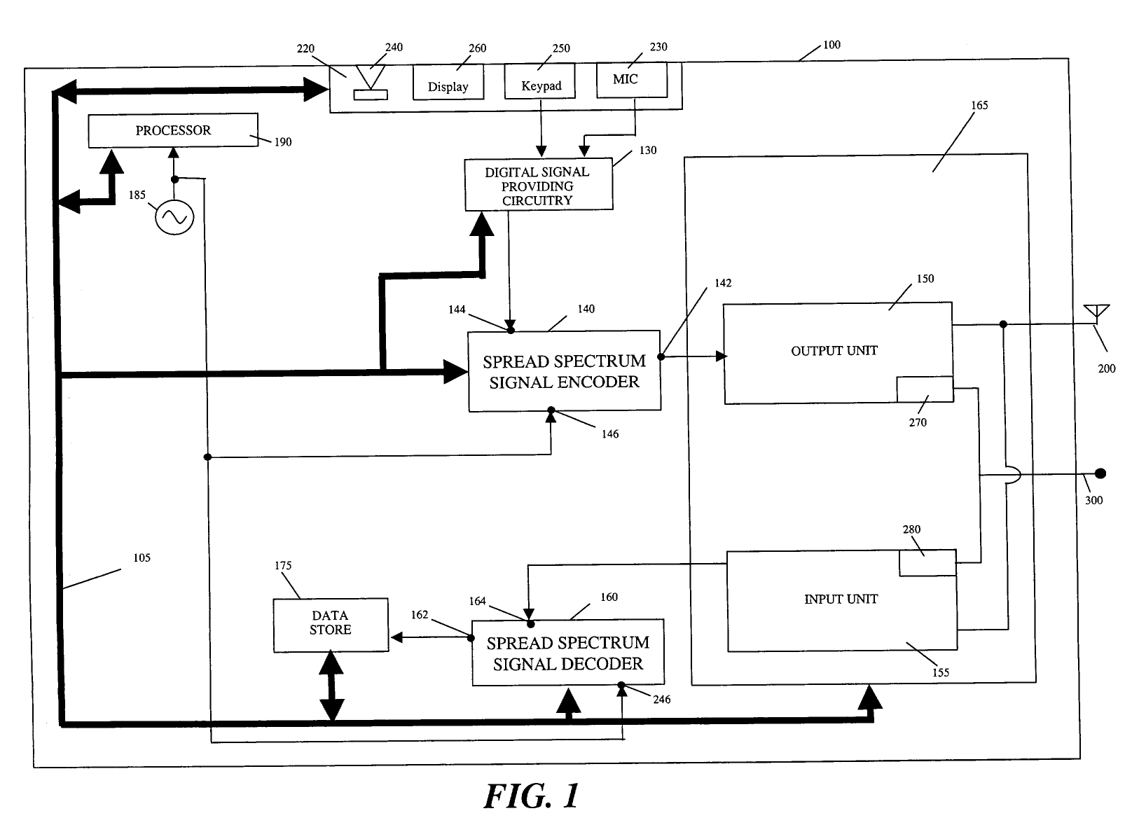

Referring to FIG. 1 there is illustrated a schematic block diagram of an electronic device 100 for providing a spread spectrum signal. The electronic device 100 is typically a single or two way radio communication device, it may also form part of a computer or other processing unit coupled to a network by a wired communication link or radio link. The electronic device 100 includes a spread spectrum signal encoder 140 and a digital signal providing circuitry 130 coupled to a signal input 144 of spread spectrum signal encoder 140. There is also an output unit 150 coupled to an output 142 of spread spectrum signal encoder 140.

The electronic device 100 also includes a spread spectrum signal decoder 160 with an input 164 coupled to an input unit 155 by a buffer (not illustrated) that forms part of input unit 155. An output 162 of the spread spectrum signal decoder 160 is coupled to a digital data store 175. In order to provide synchronization, the electronic device 100 includes a clock 185 coupled to a processor 190 (with associated memory not shown), an input 146 of spread spectrum signal encoder 140 and an input 246 of spread spectrum signal decoder 160. The output unit 150 includes a radio transmitter coupled to a common antenna 200. The input unit 155 includes a radio receiver coupled to the common antenna 200. The output unit 150 and input unit 155 form part of a communication port 165. Further, a transmitter modem 270 forms part of output unit 150 and a receiver modem 280 forms part of input unit 155. Alternatively, output unit 150 and input unit 155 may be compatible for direct network connection (by a wired communication link or otherwise), and provide an Ethernet port at a port node 300 of the communication port 165.

There is also a user interface 220 having, in one embodiment, a microphone 230, a speaker 240, an input command or data device, typically in the form of a interactive display screen or keypad 250, and an optional display screen 260. The microphone 230 and keypad 250 are coupled to the digital providing circuitry 130. A combined data and address bus 105 couples processor 190 to the user interface 220, the spread spectrum signal encoder 140, the spread spectrum signal decoder 160, the digital providing circuitry 130, the data store 175 and the communication port 165.

As will be apparent to a person skilled in the art, the digital signal providing circuitry 130 is a memory buffer for storing digitised speech, text or data. Similarly, the data store 175 is a memory for storing received data or information received by the input unit 155 and decoded by decoder 160. The stored received data or information is subsequently accessed by the processor 190 or it may be sent to the speaker 240 (after processing) or display screen 260.

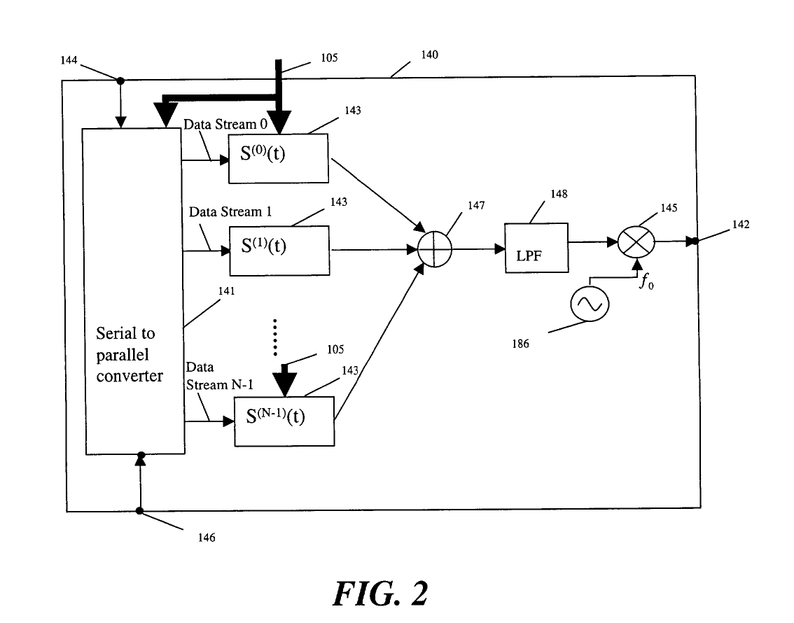

Referring to FIG. 2 there is illustrated a schematic block diagram of the spread spectrum signal encoder 140 comprising a serial to parallel converter 141 with N output data streams (data stream 0 to data streams N−1) and an input provided by signal input 144. The N data streams are coupled to a respective one of a plurality data stream spreading modules 143 and the bus 105 is coupled to both the serial to parallel converter 141 and data stream spreading modules 143. An output of each data stream spreading module 143 is coupled to an input of an adder 147 the output of which is coupled to a modulator 145 by a spectral shaping low pass filter 148. The input 146 of spread spectrum signal encoder 140 provides a clock signal input to the serial to parallel converter 141 and an oscillator 186 provides a modulation carrier frequency fₒ to the modulator 145. The modulator 145 is coupled to the output unit 150 through the output 142.

The data stream spreading modules 143 each have a processor and memory, the memory having a complementary code spreading signal S(t) loaded, at device start up, via the bus 105. However, in one alternative embodiment the respective complementary code spreading signal S(t) may be pre-programmed into the memory of each of the data stream spreading modules 143. The complementary code spreading signal S(t) is derived from the following:

Let C₀[j],C₁[j], . . . C_{N-1}[j] denote a set of N complementary sequences of length P. According to the complementary properties of these sequences, the sum of their respective auto-correlation functions will be zero at any non-zero offset as illustrated by equation (1) as follows:

$${\sum }_{i = 0}^{N - 1} {φ}_{{c}_{1} , {c}_{i}} [ j ] = 0 , for j \neq 0 \qquad ( 1 )$$

where φ_{c}_{₁}_{,c}_{₁}[j] denotes an auto-correlation function of sequence Cᵢ[j]. By multiplying each sequence from the set of complementary sequences with a corresponding waveform from an orthogonal waveform set W₀(t), W₁(t), . . . , W_{N-1}(t) and adding all the products together, the complementary code spreading sequence S(t) is generated by the following equation:

$$S ( t ) = {\sum }_{i = 0}^{N - 1} {\sum }_{j = 0}^{P - 1} {C}_{i} [ j ] {W}_{i} ( t - {jT}_{s} ) \qquad ( 2 )$$

where Tₛ is the time duration of the orthogonal waveforms. As will be apparent to a person skilled in the art, a cross correlation of any two of the orthogonal waveforms of the set W₀(t), W₁(t), . . . , W_{N-1}(t) is zero.

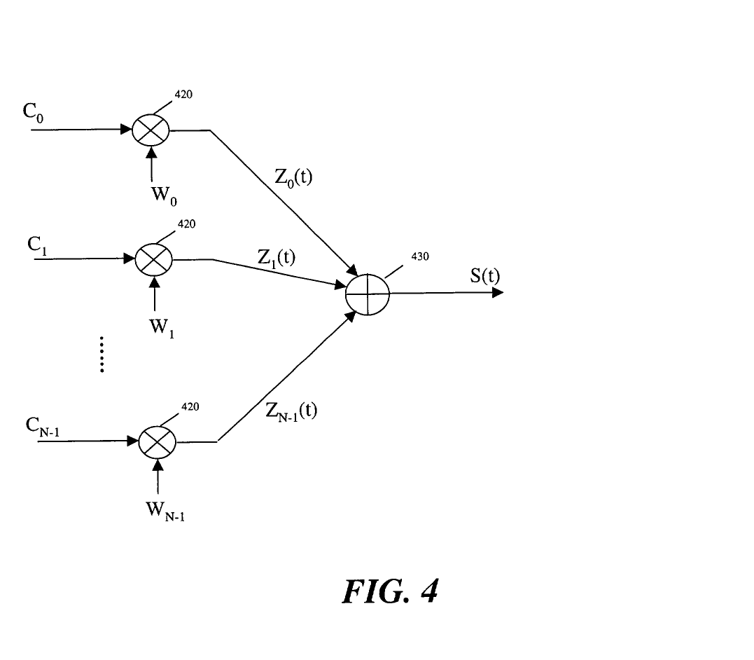

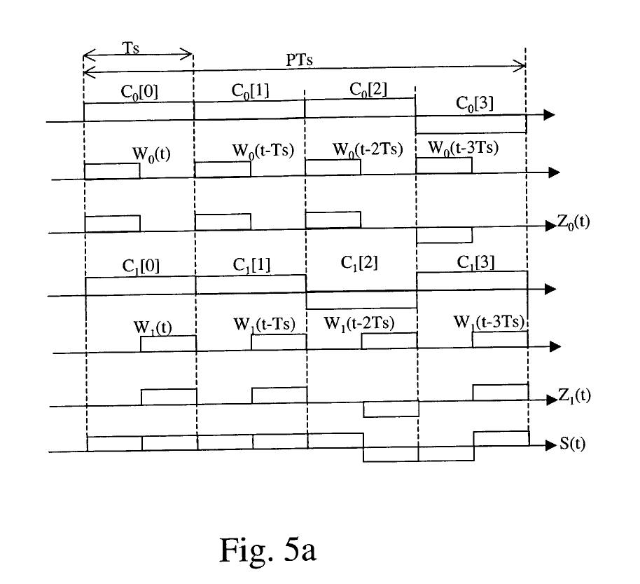

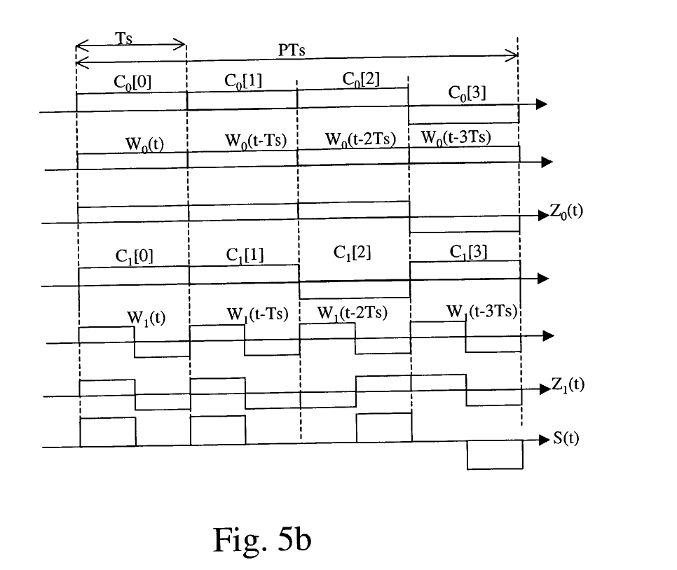

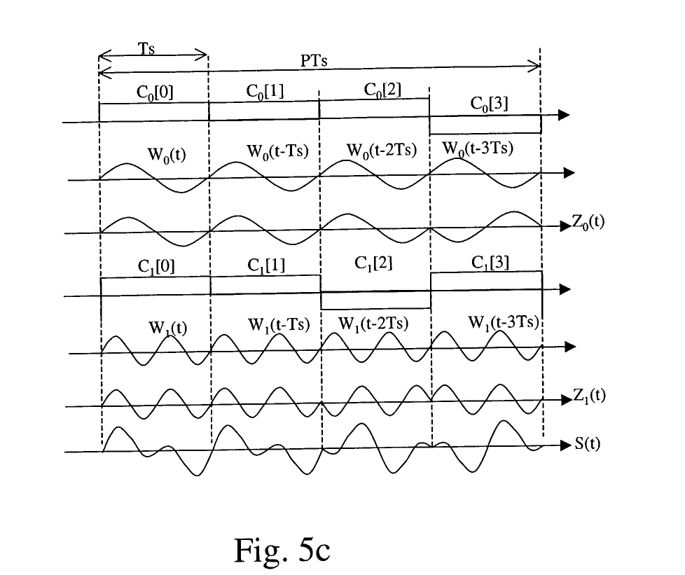

The derivation of the complementary code spreading signal S(t) can also be illustrated with reference to FIG. 4. In FIG. 4 there is illustrated N modulators 420 each having an inputs receiving one of the N complementary sequences C₀ to C_{N-1}. A modulation input of each of the modulators receives a corresponding one of the orthogonal waveform set W₀ to W_{N-1}. Each one of the modulators 420 provides a corresponding output signal Z₀ to Z_{N-1} that is received by an input of an adder module 430 the output of which provides the complementary code spreading signal S(t). For example, if there are only two complementary sequences C₀ and C₁ in the set of spreading sequences and these sequences are C₀={+1, +1, +1, −1} and C₁={+1, +1, −1, +1} (length P=4), then if a time division orthogonal waveform set W₀ and W₁ are used the complementary code spreading signal S(t) of FIG. 5a will be created. If a code division orthogonal waveform set W₀ and W₁ is used then the complementary code spreading signal S(t) of FIG. 5b will be created. Further, if a frequency division waveform set W₀ and W₁ is used then the complementary code spreading signal S(t) of FIG. 5c will be created.

As will be apparent to a person skilled in the art, no matter what kind of orthogonal waveform set W₀ to W_{N-1} is used, S(t) will always demonstrate the property that its auto-correlation function is zero, for any non-zero offset which is at integer multiple of Tₛ as illustrated by equation (3).

φ_{s,s}(t)=0, for t=−(P−1)Tₛ, . . . ,−Tₛ,Tₛ, . . . ,(P+1)Tₛ (3)

Thus at times Tₛ, 2Tₛ, 3Tₛ and so on the auto-correlation function for S(t) is zero and as will be apparent to a person skilled in the art Tₛ is also a data symbol or data bit stream time interval.

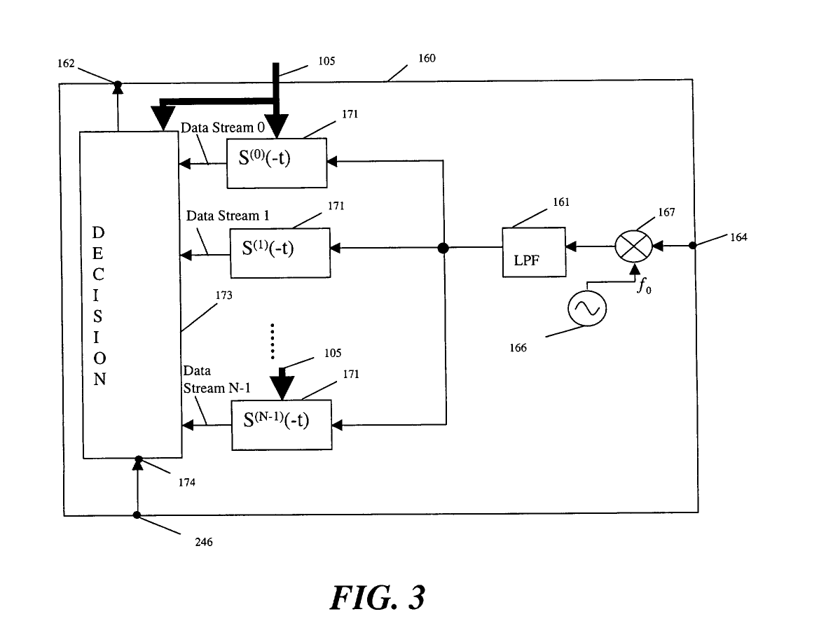

Referring to FIG. 3 there is illustrated a schematic block diagram of the spread spectrum signal decoder 160 comprising a demodulator 167 having an input coupled to the input 164. An output of the demodulator 167 is coupled to a low pass filter 161 and an output of the low pass filter 161 is coupled to a plurality of dispreading modules 171. Each despreading module 171 is coupled to bus 105. Outputs of each despreading module 171 are coupled to a decision module 173 with an output coupled to a data store 175 via the output 162. The combined outputs of the dispreading modules 171 provide a plurality of N data streams (data stream 0 to data stream N−1). The input 246 of spread spectrum signal decoder 160 provides a clock signal to a clock signal input 174 of decision module 173. The spread spectrum signal decoder 160 has an oscillator 166 with an output providing a demodulation carrier frequency fₒ to the demodulator 167.

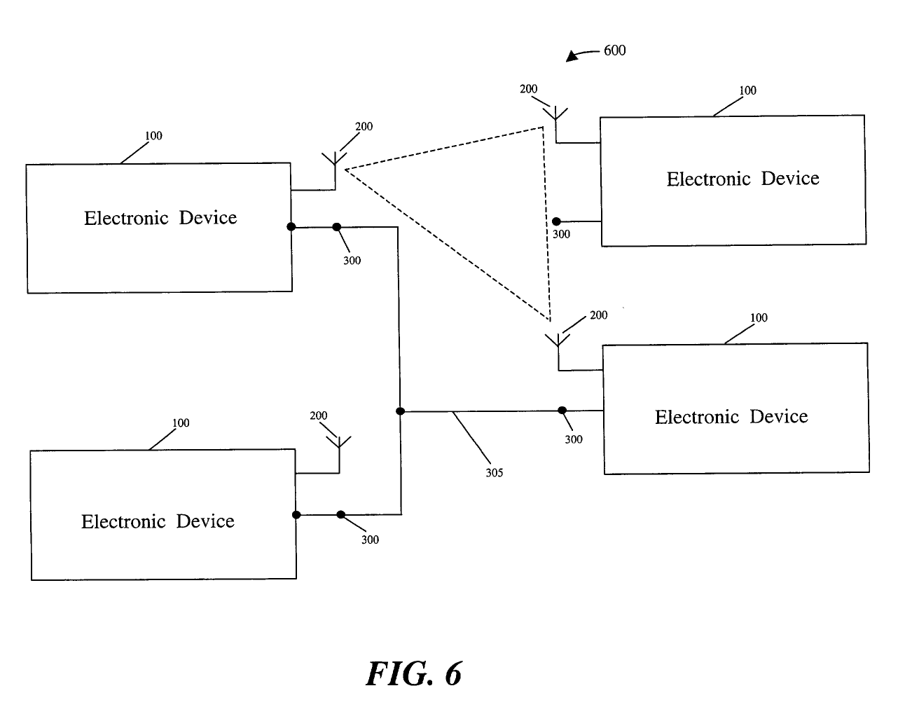

In FIG. 6 there is illustrated a schematic block diagram of a spread spectrum signal communication system 600 comprising a plurality of electronic devices 100 communicating with each other either by port nodes 300 coupled by the wired communication links 305 or by the antenna 200 using radio waves.

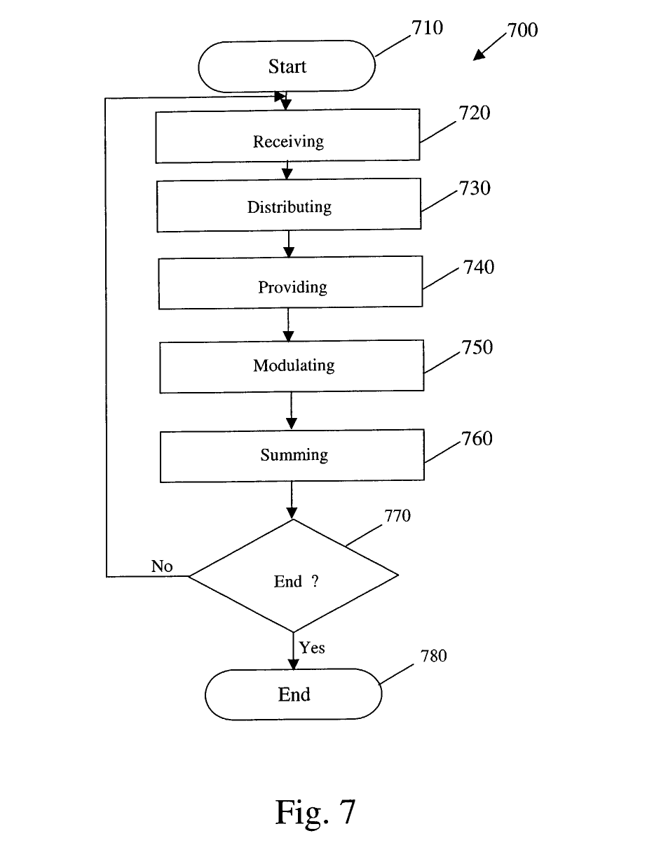

Referring specifically to FIG. 7 and generally to FIGS. 1 to 6, there is illustrated a method 700 for creating a spread spectrum signal. The method 700 of the present invention, in use, operates such that a start step 710 is invoked by activation of the user interface 220. The spread spectrum signal encoder 140, at a receive step 720, typically receives a serial data stream of bits a0 to am from the user interface 220 via the digital signal providing circuitry 130. The serial to parallel converter 141 of the spectrum signal encoder 140 converts and distributes, at a distributing step 730, the serial data stream of bits a0 to am into a plurality of parallel data bits (each bit forming part of the data streams 0 to N−1).

Each of the data stream spreading modules 143, at a providing step 740, effects the process of providing the complementary code spreading signal S(t) having an auto-correlation function of zero, for any non-zero offset, at integer multiples of a selected time interval. Then at a modulating step 750, the data stream spreading modules 143 provide for modulating the data stream with the complementary code spreading signal S(t) to provide a spread spectrum signal. The complementary code spreading signal S(t) is obtained from:

(i) providing the set of complementary sequences C₀[j], C₁[j], . . . , C_{N-1}[j] with the property that the sum of their respective auto-correlation functions is zero for any non-zero offset, at integer multiples of a selected time interval;

(ii) providing the orthogonal waveform set W₀(t) , W₁(t) , . . . , W_{N-1}(t) of at least two orthogonal waveforms, wherein a cross correlation of any two of the orthogonal waveforms of the set is zero;

(iii) Multiplying each of the complementary sequences with a respective one of the orthogonal waveforms to provide intermediate spreading signals Z₀(t) to Z_{N-1}(t); and

(iv) Summing the intermediate spreading signals Z₀(t) to Z_{N-1}(t) to provide the complementary code spreading signal S(t).

At a summing step 760, each spread spectrum signal at the output of a respective data stream spreading module is summed by the adder 147 with other spread spectrum signals that are generated by other complementary code spreading signals to provide a combined spread spectrum signal. It should be noted that all the complementary code spreading signals S(t) have an auto-correlation function of zero, for any non-zero offset, at integer multiples of a selected time interval.

This combined spread spectrum signal is filtered by filter 148 and modulated by modulator 145 and then supplied to the output unit 150 that transmits the combined spread spectrum signal by the wired communication links 300 or by radio waves linked by the antenna 200.

The method 700 repeats steps 720 to 760 until an end test step 770 detects and end of transmission signal from the user interface 220 that results in an end of transmission step 780.

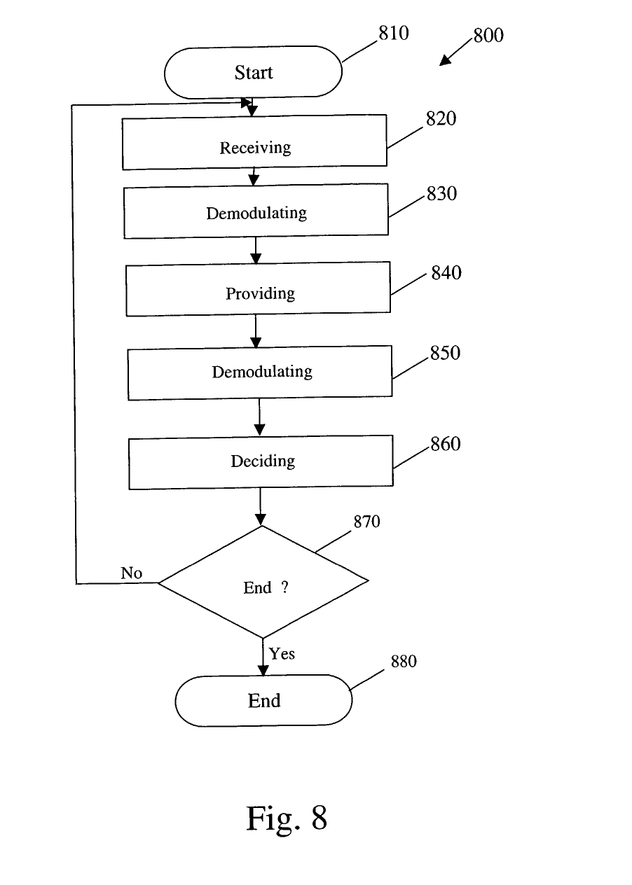

Referring to FIG. 8 there is illustrated a method 800 for decoding a spread spectrum signal to provide a data stream. The method 800 of the present invention, in use, operates such that a start step 810 is invoked by either activation of the user interface 220 or automatically upon receipt of an incoming recognizable combined spread spectrum signal at the input unit 155. The electronic device 100 receives, at a receiving step 820, the combined spread spectrum signal via the wired communication links 300 or by radio waves linked by the antenna arrays 200. The received combined spread spectrum signal is amplified by the input unit 155 and sent to the spread spectrum signal decoder 160.

At a demodulating step 830, the combined spread spectrum signal is demodulated by demodulator 167 and filtered by filter 161. At a providing step 840, each of the despreading modules 171 effects the process of providing the complementary code dispreading signal D(t) having an auto-correlation function of zero, for any non-zero offset, at integer multiples of a selected time interval. The dispreading modules also, at a demodulating step 850, provide for demodulating the spread spectrum signal with the complementary code despreading signal D(t) to provide a data stream. The complementary code despreading signal D(t) is obtained in an identical manner to that of the complementary code spreading signal S(t) and therefore to avoid repetition the derivation of the despreading signal D(t) is not recited and as a person skilled in the art can refer to the derivation of S(t) described above.

At a deciding step 860, the decision module 173 compares the output data streams 0 to N−1 from the dispreading modules 171 against a threshold to provide a decoded bits (or bit sequences) for each of the data streams 0 to N−1. The decoded bits (or sequences) are combined into a decoded bit stream and then stored in data store 175 for subsequent sending to user interface 220 or processing by processor 190.

The method 800 repeats steps 820 to 860 until an end test step 870 detects and end of transmission signal from the user interface 220 or when no further incoming recognizable combined spread spectrum signal is received from the input unit 155. This results in an end of transmission step 880.

Advantageously, the present invention provides for a spreading signal that has an auto-correlation function of zero, for any non-zero offset, at integer multiples of a selected time interval. Accordingly, the undesirable effects of inter-symbol interference is substantially reduced and relatively high speed data transmission can be achieved.

The detailed description provides a preferred exemplary embodiment only, and is not intended to limit the scope, applicability, or configuration of the invention. Rather, the detailed description of the preferred exemplary embodiment provides those skilled in the art with an enabling description for implementing a preferred exemplary embodiment of the invention. It should be understood that various changes may be made in the function and arrangement of elements without departing from the spirit and scope of the invention as set forth in the appended claims.

We claim:

1. A method for creating a spread spectrum signal, the spread spectrum signal being created by the steps of:
providing a complementary code spreading signal having an auto-correlation function of zero, for any non-zero offset, at integer multiples of a selected time interval; and
modulating a data stream with the complementary code spreading signal to provide the spread spectrum signal.

2. A method for creating a spread spectrum signal as claimed in claim 1, wherein the complementary code spreading signal is obtained from the steps of:
providing a set of complementary sequences with the property that the sum of their respective auto-correlation functions is zero for any non-zero offset;
providing an orthogonal waveform set of at least two orthogonal waveforms, wherein a cross correlation of any two of the orthogonal waveforms of the set is zero;
multiplying each of the complementary sequences with a respective one of the orthogonal waveforms to provide intermediate spreading signals; and
summing the intermediate spreading signals to provide said complementary code spreading signal.

3. A method for creating a spread spectrum signal as claimed in claim 2, wherein the orthogonal waveform set is a time division orthogonal waveform set.

4. A method for creating a spread spectrum signal as claimed in claim 2, wherein the orthogonal waveform set is a code division orthogonal waveform set.

5. A method for creating a spread spectrum signal as claimed in claim 2, wherein the orthogonal waveform set is a frequency division waveform set.

6. A method for creating a spread spectrum signal as claimed in claim 2, wherein the spread spectrum signal may be summed with other spread spectrum signals that are generated by other mutually orthogonal complementary code spreading signals, and wherein all complementary code spreading signals have an auto-correlation function of zero, for any non-zero offset, at integer multiples of a selected time interval.

7. A method for decoding a spread spectrum signal to provide a data stream, the method comprising the steps of:
providing a complementary code despreading signal having an auto-correlation function of zero, for any non-zero offset, at integer multiples of a selected time interval; and
demodulating the spread spectrum signal with the complementary code despreading signal to provide said data stream.

8. A method for decoding a spread spectrum signal as claimed in claim 7, wherein the complementary code despreading signal is obtained from the steps of:
providing a set of complementary sequences with the property that the sum of their respective auto-correlation functions is zero for any non-zero offset;
providing an orthogonal waveform set of at least two orthogonal waveforms, wherein a cross correlation of any two of the orthogonal waveforms of the set is zero;
multiplying each of the complementary sequences with a respective one of the orthogonal waveforms to provide intermediate despreading signals; and
summing the intermediate despreading signals to provide said complementary code despreading signal.

9. A method for decoding a spread spectrum signal as claimed in claim 8, wherein the orthogonal waveform set is a time division orthogonal waveform set.

10. A method for decoding a spread spectrum signal as claimed in claim 8, wherein the orthogonal waveform set is a code division orthogonal waveform set.

11. A method for decoding a spread spectrum signal as claimed in claim 8, wherein In the orthogonal waveform set is a frequency division waveform set.

12. An electronic device for providing a spread spectrum signal, the device comprising:
a spread spectrum signal encoder having at least one input coupled to an output of signal providing circuitry;
an output unit coupled to spread spectrum signal encoder, wherein, in use, the encoder modulates a data stream provided from the signal providing circuitry with a complementary code spreading signal to provide the spread spectrum signal, the complementary code spreading signal having an auto-correlation function of zero, for any non-zero offset, at integer multiples of a selected time interval.

13. An electronic device for providing a spread spectrum signal as claimed in claim 12, further including an input unit coupled to a spectrum signal decoder, wherein the spectrum signal decoder decodes a received spread spectrum signals received at the input unit to provide a decoded data stream.

14. An electronic device for providing a spread spectrum signal as claimed in claim 12, wherein the spread spectrum signal encoder comprises a plurality of data stream spreading modules coupled to an adder, wherein in use data streams are provided to the spreading modules to provide a respective spread spectrum signals that is summed together, the respective spread spectrum signals being generated by associated mutually orthogonal complementary code spreading sequences, wherein all complementary code spreading signals have an auto-correlation function of zero, for any non-zero offset, at integer multiples of a selected time interval.

15. An electronic device for providing a spread spectrum signal as claimed in claim 12, wherein the electronic device forms part of a spread spectrum system comprising at least one further said electronic device in communication therewith.
